(19) United States
(12) Patent Application Publication
(10) Pub. No.: US 2006/0057319 A1
(43) Pub. Date: Mar. 16, 2006

(54) Methods and systems for making fiber reinforced products and resultant products

(76) Inventors: Klaus Friedrich Gleich, Highlands Ranch, CO (US); Gary Alan Pollman, Sylvania, OH (US)

Correspondence Address: JOHNS MANVILLE INTERNATIONAL, INC., 717 SEVENTEENTH STREET, DENVER, CO, 80202, US

(21) Appl. No.: 10/939,015

(22) Filed: Sep. 11, 2004

(51) Int. Cl. B32B 27/32

(52) U.S. Cl. 428/35.2

(57) ABSTRACT

Methods and systems for making fiber reinforced moldable mixtures for making FRP products by mixing and/or compounding of at least one, normally hot, polymer and at least one wet fiber product. Intermediate FRP moldable mixtures and finished FRP products produced by the methods and systems are also disclosed. The polymers preferred are thermoplastic polymers, but mixtures that form thermoset polymers are can also be used. Wet fiber product(s) containing water, a solvent, or other liquid are used by the systems and methods disclosed. Packaged wet roving fiber strand products are also disclosed. The FRP products made with the invention have lower cost, more complete and uniform fiber dispersion and/or more uniform and improved appearance and/or physical properties than conventional FRP products made using conventional dry reinforcing fiber products.

This invention includes methods and systems for making fiber reinforced polymer (FRP) products, particularly long fiber reinforced products and to the intermediate fiber reinforced moldable mixtures produced. The processes and systems are useful in making fiber reinforced polymer (FRP) products having one or more of lower cost, better fiber dispersion, improved appearance, fewer defects, particularly surface defects, better uniformity including surface uniformity, and better physical properties.

Chopped strand reinforced products such as chopped strand for thermoplastics, usually comprising many glass fibers but also carbon, ceramic or polymer fibers, alone or in combination, are typically made from pellets, or other form, of one or a mixture of polymers having dispersed fibers therein. These pellets, etc., are typically made by feeding dry bundles of fibers containing up to several thousand fibers, typically having a length of about 0.125 to about 0.25 inch or even up to 0.5, into a compounding or extruding machine along with one or more polymers and heating with high shear mixing to plasticize the polymer(s) and disperse the fibers therein. To achieve good feeding characteristics in the dry fiber bundles, important to the users, a substantial amount of film former or binding agent is used in the chemical sizing coated on each fiber to prevent filamentation during storage, shipment and handling. Filamentation is the breaking down of the bundles resulting in excessive small bundles and individual fibers in the product, the presence of which causes bridging in the feeding bin cones, and other fiber handling equipment resulting costly scrap and downtime.

Fiber products used to make FRP have a sizing coating on the fibers. These sizings are known and normally contain a coupling agent such as one or more silanes, one or more lubricants and one or more film formers or binders, and can contain other ingredients such as dispersants, fillers, stabilizers and others. The sizings are normally applied as an aqueous slurry, solution or emulsion, but liquids other than water are sometimes used including a solvent for at least one of the sizing ingredients. The higher amount of bonding agent(s) used in the sizing on the fibers results in stronger fiber to fiber bonding in the bundles. This is good for fiber handling characteristics, but not good for later processing and final product characteristics. Once in the compounder and in contact with the polymer(s) it is usually desirable that the bundles separate into individual fibers and that the fibers disperse thoroughly in the polymer(s). The time and amount of mixing action to accomplish this has a practical limit, and because of the bond strength between the fibers, very high shear mixing is required to achieve a suitable degree of filamentation, fiber dispersion and wet out (coating of the fibers with the polymer or polymer mixture). This very high shear damages the surface and breaks the fibers, and also falls short of complete fiber dispersion. As a result, the reinforced plastic parts produced do not reach the potential in surface characteristics and physical properties. Most product and process development work in this area is aimed at addressing these problems and opportunities.

Potential cost reduction opportunities also exist in the chopped fiber bundle manufacturing processes. The fiber bundles are made by pulling fibers from a plurality of fiberizers while the material is in a molten or plastic state, cooling the fibers, coating the fibers with water and the chemical sizing containing one or more binding agents, gathering the fibers into strands, chopping the strands into segments of desired lengths and drying the wet chopped strands in a vibrating flatbed oven and sorting the resultant dry bundles to remove undesirable small bundles and individual fibers, lumps and fuzz clumps, a significant amount of scrap. A typical process can be seen in U.S. Pat. No. 3,996,032. These types of processes produce chopped strand bundles having a wide range of diameters and containing a wide range of numbers of fibers, e.g. from just a few fibers to 4000 or more fibers per segment. The binding agents in the sizing are expensive and the significant amount of undesirable material removed during and after drying the bundles is costly scrap. Many dry chopped strand products have been produced with the above described processes and used in making fiber reinforced products of a wide variety.

Several processes have been disclosed for pelletizing or agglomerating chopped strand for addressing the problems and opportunities described above. These include U.S. Pat. Nos. 3,984,603, 4,107,250, 4,164,534, 4,840,755, 5,002,827, 5,185,204, 5,269,993, 5,578,535, 5,585,180, 5,639,807, 5,693,378, 5,868,982, 5,945,134 and WO 01/05722. While at least one of these processes produces significant improvements in fiber bundle, or pellet, agglomerate, etc., feeding characteristics, the production costs and investment are increased and the task of filamentation of the larger bundles in the polymer is not made easier, still falling short of reaching the potential in finished product costs and properties.

For many years it has been known that using longer fibers in polymers, polymer mixtures and polymer precursor mixtures produces superior properties in the molded parts and many processes have been developed to address the added problem of dispersing much longer fibers, e.g. up to at least 1.5 inch long fibers, or even continuous fibers, in the polymer or polymer mixture. Some of these processes involve feeding dry multi-end and/or dry single end (Direct wound) roving products into a compounder or the mixing section of an injection molding machine. These roving products comprise one or more continuous strands comprised of at least hundreds, or thousands, of fibers in parallel and each having a size coating containing one or more binding agents. All of the roving products are currently dried by the roving manufacturer before packaging to remove water, or solvent, necessary in the roving manufacturing process and to form a bond between the fibers to achieve strand integrity. Thus the processes using roving products to supply long fibers to a compounding or injection molding process suffer many of the same limitations and processing problems as the processes using dry fiber bundles, pellets or agglomerates as described above.

These limitations are limiting the rate of growth of fiber reinforced polymer products market share in the competition with products made of metals and other materials.

### SUMMARY OF THE INVENTION

The present invention includes methods and systems for making moldable mixtures comprising at least one type of fiber and at least one polymer or polymer precursor, the mixtures being suitable for forming FRP products. The methods all have a common theme, that wet fiber, wet fiber bundles, pellets containing wet fiber, wet fiber agglomerates, and/or wet fiber roving(s) are fed into the compounder, mixer, or fiber reinforced polymer (FRP) molding systems. The methods make a moldable material for making FRP products comprising at least one polymer or polymer precursor and reinforcing fiber comprising feeding at least one material comprising wet reinforcing fibers having a liquid on the surfaces of the fibers, metering said fibers or dried fibers into a mixer or a compounder, feeding at least one polymer or polymer precursor to the mixer or compounder, heating the wet fibers to remove the liquid and finally dispersing dry fibers in the at least one polymer to form the moldable mixture. The invention also includes FRP parts, intermediate or finished, made by these methods and systems.

By wet fibers is meant that the water, solvent or other liquid medium used to make the reinforcing fiber product is not removed or not totally removed until after the wet fiber is removed from a shipping container or package in the FRP manufacturers facility where a reinforced polymer compounding system or polymer reinforced product manufacturing system is located. By solvent is meant a non-aqueous solvent for one or more of the sizing ingredients on the surface of the fiber. By not removed or not totally removed is meant that the fiber product contains at least about 0.5, preferably at least about 1, and most preferably at least about 5 weight percent of water, solvent or processing liquid. Liquid, most often water, contents of about 2 to about 20 wt. percent, preferably about 5 to about 15 and most preferably about 5 to about 13 wt. percent are used in the present invention, but the moisture content can be lower if desired or if the fiber reinforcing material has dried out in transit and storage.

The present invention is applicable to all types of size compositions and reinforcing fiber products, including wet fibers without a size coating other than a liquid. The present invention permits the use of fibers in which the size coating contains very little or no film formers or binders, greatly expediting and improving fiber dispersion rate and degree.

The invention includes methods of making a moldable material for making FRP products comprising feeding at least one product comprising wet fibers having a liquid on the surfaces of the fibers to a fiber dryer/feeder, mixer and/or a compounder, feeding at least one polymer to the mixer and/or compounder, heating the fibers to remove at least most of the liquid and dispersing the resultant hot fibers in the at least one polymer to form a moldable mixture for making FRP products.

The invention also includes methods of making a moldable material for making FRP products comprising feeding at least one product comprising wet fibers having a liquid on the surfaces of the fibers to a mixer and/or a compounder, feeding at least one polymer to the mixer and/or compounder, and dispersing the wet fibers in the at least one heated polymer to volatilize the liquid in the fibers, venting the volatiles from the compounder or mixer and extruding the mixture to form a moldable mixture for making FRP products. If the polymer or polymer mixture is moisture sensitive, it is advisable to vent the volatiles as soon as possible in the compounding process. Venting of the compounder is known for venting volatiles coming from polymers. The moldable material of the invention can then be molded into FRP parts using any FRP forming process such as a forming process selected from the group consisting of injection molding, compression molding, sheet and profile extrusion, pultrusion, stamping, thermoforming, and blow molding. The invention includes FRP shapes make from the methods of the invention.

All kinds of thermoplastic polymers and polymer precursors and mixtures thereof used in FRP systems can be used in the methods of the invention as well as at least most of the thermoset polymers used in sheet molding compounds (SMC) and bulk molding compounds (BMC). These include polyolefins like polypropylene and polyethylene, polyamides, polyesters like polybutylene terephthalate and polyethylene terephthalate, polycarbonates, acetals, styrenics like SMA, ABS, SAN, PAN and PPO, thermoplastic urethanes, liquid crystal polymers, polyimidazole, polyether sulfone, polyphenelene sulfide and others including thermoplastic precursors, reactive thermoplastics. The thermoset polymers or thermoset polymer precursors include unsaturated polyesther, vinylesther, phenolic and epoxy resins.

The invention also includes systems for making FRP products, or mixtures for making FRP products comprising a fiber feeder capable of metering a wet fiber product, a device for metering at least one polymer and a mixer or compounder for heating and mixing the fiber and at least one polymer together to dry and disperse the fiber in the at least one polymer and to coat the fiber with the at least one polymer. The mixer can comprise a fiber drying section and drying equipment for drying the fiber and venting the volatiles from the fibers in addition to the normal mixing features. The system of the invention can include drying equipment for at least partially drying the wet fiber prior to the fiber entering the compounder or mixer. The fiber dryer can be a modified fiber feeder, a conveyor dryer or other equivalent dryers.

The invention also includes wet, packaged, fiber roving products comprising at least one strand comprising a plurality of parallel fibers having a liquid thereon in an amount of at least about 0.5, preferably at least about 1 or 2, and most preferably at least about 5 wt. percent and up to about 15 percent or more. The wet roving product can also contain two or more of the fiber strands. The diameter of the fibers in the strand typically are in a narrow diameter range with the average rangeing from about 6 microns to about 30 microns, with about 13 microns to about 23 microns being most useful. The fibers can be any type of glass, any type of carbon and graphite, and any type of ceramic material. The preferred liquid is water, particularly in glass fiber roving products. The wet roving product is packaged in a polymer sleeve, film, shrink wrap, stretch wrap or polymer bag. It is preferred to cover at least the cylindrical portion of the roving product with the package and also at least a portion of the top and bottom, but it is entirely suitable to allow exposure of at least a portion of the roving product to air to permit ambient drying or evaporation of liquid in the product during shipment and storage. The wet roving product is normally in the form of a hollow cylinder, but can be in other shapes. The size of the cylinder can be large to reduce the frequency of adding new packages of roving in the FRP manufacturing processes.

The invention also includes methods of making FRP parts or intermediate FRP moldable compound for making FRP parts comprising feeding wet fiber roving strand, such as described above, containing about 0.5-15 wt. percent of a liquid like water or a solvent into an FRP compounder, or optionally first into a dryer for reducing the liquid content of the strand and then into the FRP compounder, mixing the resultant fiber with at least one heated polymer to break the fibers in the strand into varying lengths and to disperse the fiber in the at least one polymer to form a mixture that is moldable into an FRP part. The invention also includes FRP products produced by these methods.

The invention also includes mixtures for making FRP products comprising fibers comprising at least about 0.5 wt. percent and up to about 1-15 wt. percent of a liquid, preferably water, or a solvent, and at least one polymer.

The invention also includes FRP intermediate and finished products made by the above methods of the invention in which the liquid has been entirely or substantially removed in the process.

The invention also includes a method comprising feeding wet rovings of the invention into a fludized bed where they are coated with a thermoplastic powder and on into an oven where the moisture or solvent in the roving is removed in a first stage of the oven followed by the heating of the roving fibers and the melting of the powder in a second stage. The hot coated continuous fibers are then accumulated and consolidated and/or formed of coated into the desired FRP intermediate product or finished part. One or more fiber webs, coated or uncoated, can be fed into and/or onto the coated fibers to provide lateral reinforcement between the coated rovings. The invention also includes FRP products made by these methods.

The invention also includes a method comprising feeding wet rovings of the invention into a polymer melt impregnation system where the fibers are dried, the volatiles removed and the fibers are coated with the polymer melt and then formed to shape and cooled to form FRP intermediate or finished parts. One or more fiber webs, coated or uncoated, can be fed into and/or onto the coated fibers to provide lateral reinforcement between the coated rovings. The invention also includes FRP products made by these methods.

When the word “about” is used herein it is meant that the amount or condition it modifies can vary some beyond that so long as the advantages of the invention are realized. Practically, there is rarely the time or resources available to very precisely determine the limits of all the parameters of ones invention because to do would require an effort far greater than can be justified at the time the invention is being developed to a commercial reality. The skilled artisan understands this and expects that the disclosed results of the invention might extend, at least somewhat, beyond one or more of the limits disclosed. Later, having the benefit of the inventors disclosure and understanding the inventive concept and embodiments disclosed including the best mode known to the inventor, the inventor and others can, without inventive effort, explore beyond the limits disclosed to determine if the invention is realized beyond those limits and, when embodiments are found having no further unexpected characteristics, the limits of those embodiments are within the meaning of the term about as used herein. It is not difficult for the artisan or others to determine whether such an embodiment is either as expected or, because of either a break in the continuity of results or one or more features that are significantly better than those reported by the inventor, is surprising and thus an unobvious teaching leading to a further advance in the art.

### BRIEF DESCRIPTION OF THE DRAWINGS

FIG. 1 is a schematic cross section of a compounder system according to the invention.

FIG. 1A is a schematic cross section of another compounder system according to the present invention.

FIG. 2 is a schematic cross section of another compounder system according invention.

FIG. 2A is a schematic cross section of an optional roving strand dryer for use in the invention.

FIG. 3 is schematic cross section a powder coating system of the present invention.

### DETAILED DESCRIPTION OF PREFERRED EMBODIMENTS

Typically, the wet chopped strand or wet chopped fiber used in the invention will be at least 0.12 inch long and as long as at least about 2 inches, with a preferred range being between about 0.25 inch and about 1.5 inches, most preferred being in the range of about 0.5 inch to about 1.5 inch. The majority of the fibers in the chopped strands typically have diameters of from about 6 microns to about 30 microns, preferably from about 12 to about 23 microns, but other diameters are suitable for some applications as is known. Normally most of the fibers will be in a narrow fiber diameter range and length, because this is how most chopped strand products on the market are made, but this is not necessary as the lengths and fiber diameters can be tailored to meet a specific application.

The moisture or solvent content of the wet chopped fiber strand coming from the chopper varies from about 0.5 wt. percent to about 16 wt. percent, or more. The chopped fiber can loose about 2-3 percent in the handling and packaging system at the fiber manufacturing plant including through the conventional feeding equipment feeding the compounder, injection molding machine or other FRP manufacturing system at the customers' plants. Preferably the moisture content is within the range of about 5-15 percent, and most preferably in the range of less than about 7 percent as the fiber enters the conventional FRP manufacturing equipment.

Many types of fiber can be used in the present invention including all kinds of glass fibers including E, S, C, R, and T, all kinds of ceramic fibers and whiskers, all types of carbon and graphite fibers, all types of natural mineral fibers and all types of metal fibers. Glass fibers and carbon fibers are most commonly used in FRP products and are preferred in this invention. Chopped glass fibers, chopped glass fiber strands and glass fiber rovings conventionally used in FRP processes are dried by the fiber manufacturer in processes such as shown in U.S. Pat. Nos. 4,158,555, 4,840,755 and 5,945,134, prior to shipping to FRP customers. The glass fiber roving products used in FRP manufacturing systems are also dried prior to being shipped to the FRP customers.

Wet chopped glass fibers and wet chopped glass fiber strand products are available and are used in wet process such as wet mat machines used to make nonwoven fibrous mats, stampable sheet FRP products, and gypsum wall board products. The sizing compositions on some of these products contain only one or two ingredients, e.g. U.S. Pat. No. 6,294,253. These wet products are usable in the invention as are other wet products containing more than two ingredients or different ingredients. It is preferred that the size on the fibers of both the chopped fiber products and roving products have at least one coupling agent, such as a silane, and at least one lubricant therein. The wet fiber products are usually shipped in sealed plastic bags inside a container such as a cardboard box. Conventional dried fiber products are normally stored and shipped in containers that alone would be unsuitable for shipping wet fiber. It is not critical to the products used in the present invention if they dry out partially or completely during shipment and storage, but it is necessary to protect the container from liquid in the fiber products that would cause the packaging material from loosing strength and failing due to absorption of moisture or solvent from the wet fiber. That can be done with plastic bags or plastic, wood or metal containers.

The wet roving is made in a conventional manner except the drying step, used to remove the liquid such as water or a solvent and to cure the film forming binder in the sizing on the fiber, is omitted, or greatly reduced, to leave at least 0.5, preferably at least about 2 percent liquid in the roving product. It is preferred to package and even ship the roving rolls, or roving packages with the same, or close to the same liquid content as they contain when they are removed from the roving winder on which the roving roll or roving package is formed. This liquid content, preferably moisture content, is normally at least 4 wt. percent, preferably at least 6 wt. percent and most preferably at least 8 wt. percent and normally up to about 20 wt. percent. Also, the film former or binder ingredient(s) in the sizing composition coated on the fibers can be reduced or eliminated entirely. Any of the known roving processes can be used, such as those disclosed in U.S. Pat. Nos. 5,055,119, 5,605,757, 5,957,402, 6,349,896, 6,425,545, 6,568,623, and 6,780,468, the disclosures of which are included herein by reference.

The wet roving products of the present invention can be packaged in plastic bags, plastic film, stretch wrap, shrink wrap or plastic containers. It is not necessary to completely cover the tops or the bottoms of the roving packages with the plastic packaging materials, but only enough to contain the roving rolls or roving packages and to prevent failure of the cardboard slip sheets or trays normally used to ship roving packages. It does not hurt the wet roving of the present invention to partially or even completely dry during storage, shipment or both.

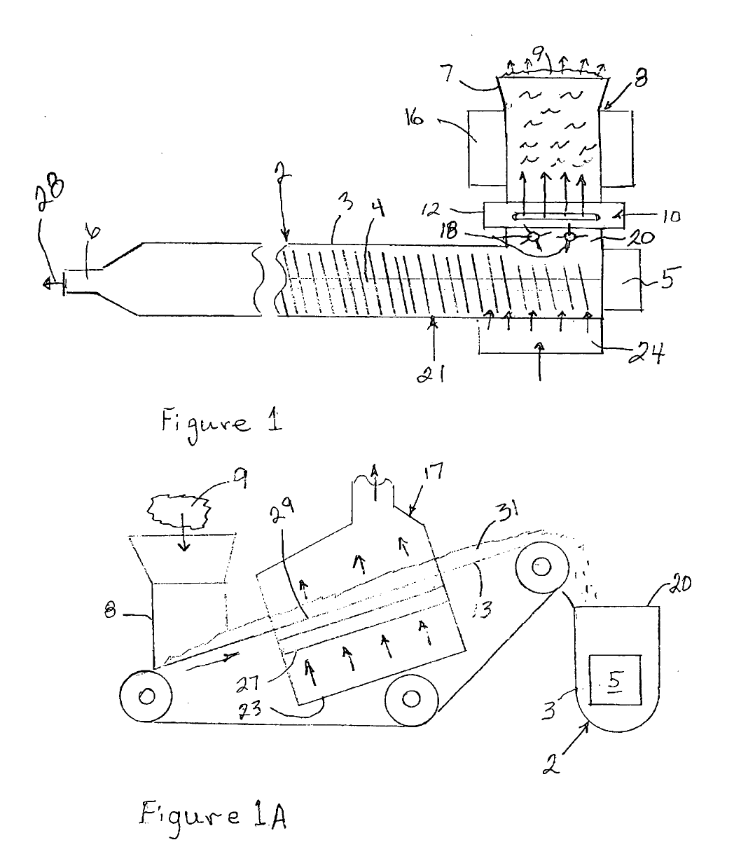

FIG. 1 is a perspective cross section of a single or double screw (with the second screw hid behind the first screw) compounder 2 system comprising a body 3, a screw or screws 4, a drive 5 and an extrusion head 6 that can be used to produce moldable mixtures of one or more polymers, fillers, reinforcing fibers and other additives. The compounder is well known and can be of various types. The compounder system shown also comprises a fiber feeder 8, such as a SolidsFlow® Model 7000 feeder available from the Schenck AccuRate® company of Whitewater, Wis. Instead a Brabender Special Fiber Feeder can be used, available from the Brabender Technologie of Mississauga, Ontario, Canada. These feeders will feed wet fiber 9 into the conventional compounder without significantly reducing the liquid content of the wet fiber. In such an embodiment of the invention the water or solvent in the fiber is volatilized in the hot compounder, particularly when coming into contact with at least one hot polymer or polymer precursor that is conventionally fed into the compounder in a conventional manner and is vented out of the compounder through the fiber entrance and other conventional vents in the compounder. The hot polymer or polymer melt is typically in a range of about 150 to about 450 degrees C. when entering the mixer or compounder.

Optionally as shown in FIG. 1, the fiber feeder 8 can be modified to enable drying air 10 at a temperature of at least about 100 degrees C., preferably in a range of about 150 to about 500 degrees C. or higher to be fed from a manifold 12, through spaced holes or preferably through a slot in the manifold that communicating with the fiber, surrounding or adjacent to a lower end of a vertical cylindrical portion 14 of the feeder 8 to dry out the wet fiber 9. An optional supplemental heater 16 that preferably is a microwave or dielectric system, a coil carrying a hot fluid or other conventional heater, surrounds at least a portion of the vertical cylindrical portion 14 of the feeder. One problem of the conventional drying systems for drying fiber in the fiber manufacturer's plants is that the hot air drying the fibers entrains fibers in the exhaust requiring a costly and troublesome system to remove the entrained fibers from the exhaust air. In this system any entrained fibers are filtered out by a layer of wet fibers at the top of the cylindrical portion 14 and the wet fibers are not easily entrained by the air stream exhausting from the wet fibers at the top of the fiber column.

One or more optional driven agitators 18 can be positioned below the vertical cylindrical portion 14 above or in a fiber entrance 20 of the compounder 2. The agitators 18 can be of the shaft and pin type spaced apart so that the pins on the shaft almost contact each other and walls of the fiber entrance 20 so that the agitators 18 control the feed rate of the dried fiber into the body 3 of the compounder 2 and also prevent any bridging of the fiber in the fiber entrance 20. The drying air 10 is preferably at a temperature safely below that which would deteriorate the sizing lubricant or sizing on the fiber. The desired polymer or polymer mixture 21 is fed into the compounder 2 in a conventional manner. Moldable mixtures 28 comprising one or more polymers and reinforcing fiber is extruded by the compounder 2 through various extrusion heads 6, either directly into conventional injection or other known molding systems to make FRP sheets and final profiles, or as moldable or stampable sheets or shapes that can be cut to desired size and molded in presses in a conventional manner.

The compounder 2 is normally heated in a conventional manner and the fiber, now dry or containing some water or solvent can be, but need not be, warm or hot when first contacting the polymer or polymer mixture 21 aiding the wet out of the fibers. Other, more conventional systems for drying the fiber can be used prior to the SolidsFlow® feeder or other fiber feeder 8.

An optional hot air manifold 24 partially surrounding a portion of the length of the body 3 of the compounder 2, adjacent the drive end, can be fed with hot air 25 that passes through holes in the compounder body 3 can be used instead of, or in addition to the manifold 12 and/or the heater 16 to dry or reduce the moisture or solvent content of the wet fiber 9.

FIG. 1A shows another compounder system of the invention in which a different type of dryer is used to remove part or all of the water or solvent in the fiber before feeding the fiber to the compounder 2. In this embodiment the wet fiber 9 is metered using a metering fiber feeder such as a SolidsFlow® or Brabender feeder onto a drying conveyor 11. The dryer conveyor 11 is comprised of a vibrating tray or preferably a belt conveyor 13, preferably with an air permeable metal belt, and a dryer 17. The dryer 17 can be any type of dryer capable of removing at least part the water or solvent from the wet fiber 9, such as a microwave or dielectric type, preferably with convection assist either with ambient air or heated air. Preferably, the dryer 17 is a hot air dryer with hot air 19 supplied in a conventional manner into a lower chamber 22 of the dryer 17 and through a conventional diffuser plate 23 and optionally through one or two additional diffuser plates or screens 27 and then through the air permeable belt 13 and the metered layer of wet fiber 29 to remove part or all of the water or solvent from the fiber producing a continuous metered feed of semi-dry or dry fiber 31 feeding into the fiber entrance 20 of the compounder 2. Semi-dry fiber can contain a few percent water or solvent that can be removed in the compounder 2, as described above, if desired. With some fiber products leaving a few percent of liquid in the chopped strands will provide better strand integrity until the chopped fiber strands 31 are closer to mixing with the hot polymer.

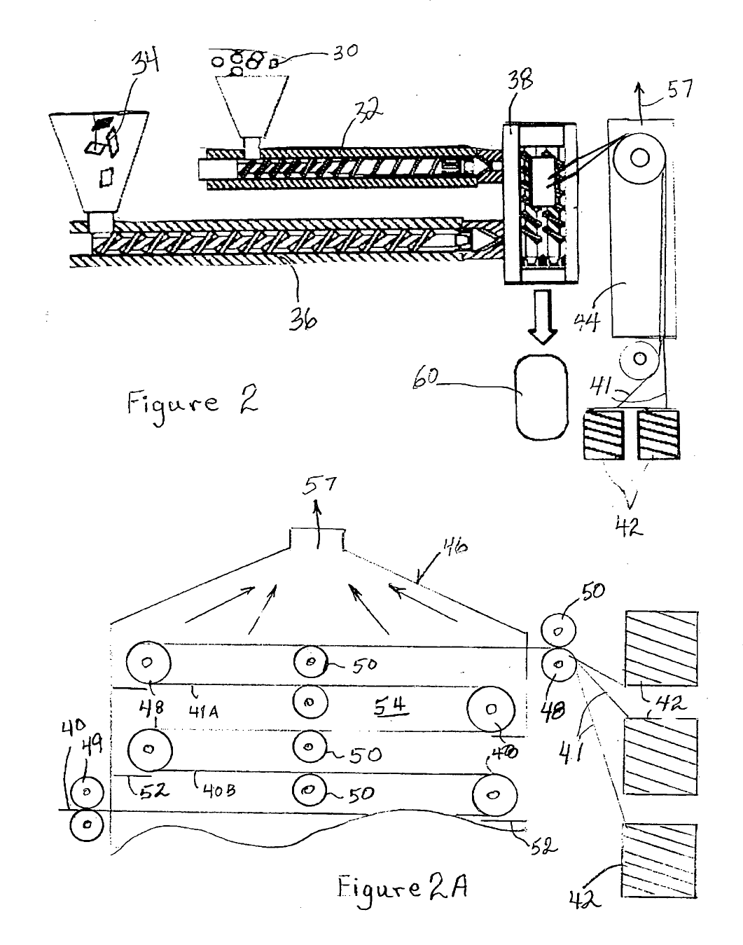

FIG. 2 is a cross section of a two extruder compounder that uses wet roving instead of or in addition to either dry reinforcing fiber or wet chopped fiber strand and is a modification of a system sometimes referred as the Dieffenbacher System, modified here according to the present invention. One advantage of using rovings in a compounder system is to place longer fibers into the resultant compound. Another advantage is the ease of handling roving packages and rovings therefrom.

In this modified system dry chopped strand fibers and one or more polymers 30 and/or recycle polymer with or without fiber reinforcement are fed into a first compounder 32 in a known manner to disperse and wet out the fibers in the one or more polymers. To use wet chopped strand according to the present invention, the first compounder 32 is fitted with a fiber feeder/dryer 8 like that shown in FIG. 1 and/or with the dryer 25 also shown in FIG. 1. Optionally, recycle reinforced polymers or long fiber compounds 34 are fed into a second compounder 34. The compounder 34 can also be modified in the same manner as described above for the first compounder 32 to use wet chopped fiber strand according to the present invention.

The output of the first compounder 32, and optionally that of the second compounder 34, feed into a twin screw, third compounder 38 in a known manner. Part way into the third compounder 38, also in a known manner, roving fiber strands, roving, 40 are fed into the compounder 38 where they are broken into long lengths by the twin screws, dispersed and wet out in the polymeric feed from the first compounder 32. The roving 40 can be completely dry or can contain a few percent, such as up to about 15 wt. percent moisture or solvent. Wet roving 41, containing at least about 0.5, preferably at least about 1, and most preferably at least about 2 wt. percent moisture or volatile solvent, and as much as about 15 wt. percent, are pulled from packages, rolls of wet roving 42 and through a roving strands dryer 44 to reduce the moisture or solvent content, or to completely dry, the roving strands 41. The roving strands dryer 44 can of many types, but a microwave/convection or dielectric/convection dryer is preferred. In this known type of dryer the microwave energy rapidly heats the water or solvent in the roving strands to cause vaporization and a countercurrent convective air flow carries the volatiles and heated air out of the dryer 44 while preheating the incoming wet strands 41. A small percentage of moisture or solvent in the incoming fiber strands 40 of rovings can be vented from the third compounder 38 in a conventional manner when volatilized by the hot material in the third compounder 38. FRP molding intermediate products 60 of the invention are produced by the compounder 38, with or without the input of the optional second compounder 36

Single or multiple pass conventional convection air dryers can also be used as the roving strands dryer 44. One multiple pass dryer 46 is shown in FIG. 2A. Hot air 47 is fed into the bottom of the dryer 46 and flows upward past dry roving strands 40 and through multiple passes of the progressively wetter roving strands 40A through 40B, 41B, 41A and 41 to heat the roving strands and moisture or solvent therein and to volatilize the same while the roving strands are moving around and over turning rollers 48 and supporting rollers 50. Baffles 52 prevent the hot air 46 from channeling up the end portions of the dryer 46. Volatile laden air 54 is exhausted through a stack 56 in the top portion of the dryer 46. A portion of the volatile laden exhaust 57 can, if desired, be recycled to blend with ambient air feeding into a heater (not shown) that produces the hot air 47. A set of powered pull rolls 49 pull the plurality of roving strands 40-41 through the dryer 46, and optionally one or more of the turning rolls 48 can also be driven at the desired pulling speed. Optionally, one side 54 or both side of the oven can be hinged (not shown) for opening to service the oven interior when necessary and to lace in the wet roving strands 41 after any interruption in the roving stream.

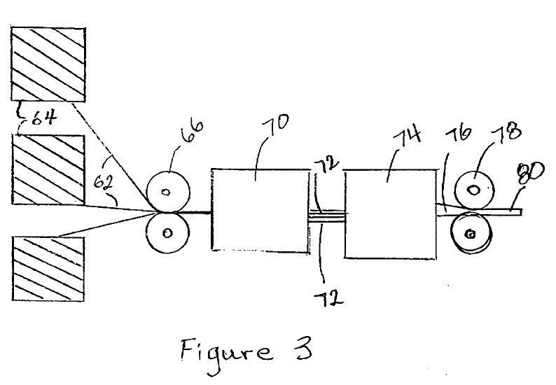

FIG. 3 is a schematic of another system for using the wet rovings according to the present invention. This is a conventional system for making FRP intermediate or finished products by powder coating fibers in roving strands or wet fiber yarn. In this embodiment of the invention, wet fiber roving or wet yarns 62 are pulled from wet roving packages or bobbins 64 with a set of driven pull rolls 66 that also spread the fibers apart into thin ribbons of wet fibers 68. The thin ribbons of wet fibers 68 are pulled through a conventional fluid bed 70 of polymer powder where the wet fibers in the thin ribbons of wet fibers 68 are coated with the resin powder. As is known the powder is usually a thermoplastic polymer, but can also contain powdered scrap, filler and other powdered additives. Powder coated wet fiber ribbons 72 are then pulled from the fluid bed 70 and into a conventional dryer/heater 74 where the coated fiber ribbons 72 are heated to volatilize and remove the moisture or solvent on the wet fibers and then to soften or melt the polymer powder on the fibers. Hot, polymer coated fiber ribbons 76 are pulled with one or more sets of pull/masticating rolls 78 to press the soft polymer or polymer mixture on the fibers into the array of fibers to finish wetting out the all of the fibers in a known manner and finally to cool the polymer to below tackiness. The resultant FRP intermediate product 80 can then be pulltruded through a die to form a desired profile FRP product, like ladder rails and structural products, etc., or can be cut into desired lengths for later stamping or pressing into a desired FRP products as known.

The polymer coated strands described in FIG. 3 can also be made by a process using a polymer impregnation die in stead of a fluid bed powder system. In this system the strands are fed through a die where the polymer is injected and impregnated into the fiber strands to make a FRP ribbon which can be chopped into lengths or pellets for later molding into FRP parts or molded into an FRP ribbon intermediate product or molded into finished FRP parts.

The materials, methods and systems of the present invention can be used with a wide variety of FRP manufacturing systems including the CPI System, the Dieffenbacher Systems, the Coperion System, the Berstorff System, the Lawton System and the fluidized bed powder coating systems, melt impregnation systems and wire coating systems. In the latter systems wet rovings of the invention are coated with a thermoplastic powder or melt and the moisture or solvent in the roving is then removed in the first stage of an oven or first stages of the impregnation process followed in the powder coating process by the melting of the powder and in all by the accumulation and consolidation and/or forming of coated fibers into the desired FRP parts. One or more fiber webs, coated or uncoated, can be fed into and/or onto the coated fibers to provide lateral reinforcement between the coated roving fiber strands.

### EXAMPLE 1

More and more automotive parts such as door modules, instrument panels, runner board and others are made from long fiber reinforced Polypropylene. All these parts require a perfect surface (no fiber bundles showing up on the surface) and are in most cases totally or partially textured. Using the existing technologies, a higher amount of scrap rate due to surface quality problems could be found. A good use for the invention is the production of such automotive components with stringent surface requirements.

A mixture of a polyproylene resin and conventional additives are fed into an inline compounding system like a Dieffenbacher system. The fiber a fed by a gravimetric special fiber feeder downstream in the transition between the two extruders. The melt, coming from the compounding extruder, and the fiber are combined and fed into a second short twin screw system. The moisture in the wet fiber volatilizes or evaporates out of the feeding area and/or downstream and is removed by using a venting system in the twinscrew extruder. The material is than deposited on a belt, moved into an open tool or mold and a part is compression molded.

The molded part has a superior dispersion and a superior surface quality compared to the part manufactured with the prior art systems using conventional dry fiber products. The improved properties of the parts made using the invention will reduce the scrap rate of such parts and warpage, caused by uneven distribution of fiber/fiber bundles, and has a positive influence on the resulting mechanical properties of the improved parts.

### EXAMPLE 2

The invention can be used to produce fiber reinforced Nylon parts such as runner boards in a one step injection molding process without pre-compounding. The fibers are metered to a belt using a gravimetric controlled feeder like a Brabender fiber feeder available from Brabender Technologie, Inc. of Mississauga, Ontario, Canada, and dried by running the conveyor belt through an oven. The fibers are than combined with the resin and the additives and fed into an injection molding machine. The easy to disperse wet fiber produces the necessary wet out and fiber distribution in an injection molding machine with only very limited fiber degradation. After melting and mixing, the resulted fiber reinforced Nylon is injection molded or injection compression molded into the final part.

The advantages of the present invention include a reduction in the cost of making chopped strand products due to the reduction of expensive sizing ingredients, particularly film formers and binders, and in eliminating drying which reduces scrap losses, handling costs, capital investment, and energy costs. Advantages also include improved performance of the reinforcing fiber through faster and better dispersion and wet out and improved properties in the FRP products including uniformity, surface smoothness and appearance and better physical properties. The increased freight costs, capital investment costs and energy costs in the FRP processes to ship heavier wet chopped strand and wet roving products, and to dry the wet chopped strand and wet roving products is more than offset by the advantages listed above.

While only preferred embodiments have been disclosed in detail above, many additional embodiments are possible and obvious to one of ordinary skill given the above disclosure and the claims are intended to include such embodiments and obvious equivalents thereof. For example, it will be within the skill of an ordinary artisan, given the above disclosure, to use the above disclosed invention to make FRP products from roving and chopped strands having all or most kinds of sizing compositions on the surface of the fibers or only water or a solvent on the surface of the fibers. Other know methods of packaging, of feeding, of drying and of compounding the wet fibers can be used without changing the nature of the invention.

1. A method of making a moldable material for making FRP products comprising at least one polymer or polymer precursor and reinforcing fiber comprising feeding at least one material comprising wet reinforcing fibers having a liquid on the surfaces of the fibers, metering said fibers or dried fibers into a mixer or a compounder, feeding at least one polymer or polymer precursor to the mixer or compounder, heating the wet fibers to remove the liquid and finally dispersing dry fibers in the at least one polymer to form the moldable mixture.

2. The method of claim 1 wherein the fibers comprise glass fibers.

3. The method of claim 1 wherein the fibers contain at least about 2 wt. percent liquid.

4. The method of claim 2 wherein the fibers contain at least about 2 wt. percent liquid.

5. The method of claim 1 wherein the fibers are in the form of chopped strand having a length between about 0.12 and about 1.5 inches.

6. The method of claim 2 wherein the fibers are in the form of chopped strand having a length between about 0.12 and about 1.5 inches.

7. The method of claim 3 wherein the fibers are in the form of chopped strand having a length between about 0.12 and about 1.5 inches.

8. The method of claim 4 wherein the fibers are in the form of chopped strand having a length between about 0.12 and about 1.5 inches.

9. The method of claim 1 wherein the wet fibers are first removed from a shipping container and heated to volatilize at least a major portion of the liquid prior to putting the fibers into the mixer or compounder.

10. The method of claim 2 wherein the wet fibers are first removed from a shipping container and heated to volatilize at least a major portion of the liquid prior to putting the fibers into the mixer or compounder.

11. The method of claim 3 wherein the wet fibers are first removed from a shipping container and heated to volatilize at least a major portion of the liquid prior to putting the fibers into the mixer or compounder.

12. The method of claim 4 wherein the wet fibers are first removed from a shipping container and heated to volatilize at least a major portion of the liquid prior to putting the fibers into the mixer or compounder.

13. The method of claim 5 wherein the wet fibers are first removed from a shipping container and heated to volatilize at least a major portion of the liquid prior to putting the fibers into the mixer or compounder.

14. The method of claim 1 wherein the wet fibers are in the form of at least one roving fiber strand.

15. The method of claim 2 wherein the wet fibers are in the form of at least one roving fiber strand.

16. The method of claim 3 wherein the wet fibers are in the form of at least one roving fiber strand.

17. The method of claim 4 wherein the wet fibers are in the form of at least one roving fiber strand.

18. An FRP moldable mixture prepared by the method of claim 1.

19. An FRP moldable mixture prepared by the method of claim 2.

20. An FRP moldable mixture prepared by the method of claim 3.

21. An FRP moldable mixture prepared by the method of claim 4.

22. An FRP moldable mixture prepared by the method of claim 10.

23. An FRP moldable mixture prepared by the method of claim 14.

24. An FRP moldable mixture prepared by the method of claim 15.

25. An FRP moldable mixture prepared by the method of claim 16.

26. An FRP moldable mixture prepared by the method of claim 17.

27. A method of making a moldable FRP material by coating wet reinforcing fibers having a liquid on the surfaces of the fibers with a powder comprising at least one polymer or polymer precursor and heating the wet fiber to remove at least most of the liquid from the fibers and to melt the powder to wet out the fibers with the at least one polymer or polymer precursor coating to form the moldable FRP material.

28. The method of claim 27 wherein the wet reinforcing fibers comprise glass fibers having at least about 2 wt. percent water or solvent on their surfaces.

29. The method of claim 27 wherein the fibers are in the form of at least one roving fiber strand.

30. The method of claim 28 wherein the fibers are in the form of at least one roving fiber strand.

31. A moldable FRP material made by the method of claim 27.

32. A moldable FRP material made by the method of claim 28.

33. A moldable FRP material made by the method of claim 30.

34. A method of making a moldable FRP material by coating wet reinforcing fibers having a liquid on the surfaces of the fibers with a melt comprising at least one polymer or polymer precursor thus heating the wet fiber to remove at least most of the liquid from the fibers and working the coated fibers to wet out the fibers with the melt of at least one polymer or polymer precursor to form the moldable FRP material.

35. The method of claim 34 wherein the wet reinforcing fibers comprise glass fibers having at least about 2 wt. percent water or solvent on their surfaces.

36. The method of claim 34 wherein the fibers are in the form of at least one roving fiber strand.

37. The method of claim 35 wherein the fibers are in the form of at least one roving fiber strand.

38. A moldable FRP material made by the method of claim 35.

39. A moldable FRP material made by the method of claim 36.

40. A moldable FRP material made by the method of claim 37.

41. A wet, packaged, fiber roving product comprising at least one fiber strand comprising a plurality of parallel fibers having a liquid on the surfaces of the fibers in an amount of at least about 1 wt. percent and up to about 20 wt. percent.

42. The wet roving product of claim 41 wherein the roving product is packaged in a polymer sleeve.

43. The wet roving product of claim 41 wherein the roving product is in the form of a hollow cylinder.

44. The wet roving product of claim 42 wherein the polymer sieve covers the cylindrical surface and at least a portion of a top and at least a portion of a bottom of the package.

45. The wet roving product of claim 41. wherein the roving product is sealed inside a polymer film or polymer bag to retain the liquid in the roving product.

46. A system for making a moldable mixture for making FRP products comprising a fiber feeder for metering a wet fiber product containing from about 0.5 to about 20 wt. percent of a liquid in the wet fiber product, a device for metering at least one polymer into a mixer or compounder, a mixer or compounder for mixing the fiber and at least one polymer or polymer precursor together to dry and disperse the fiber in the at least one polymer or polymer precursor and to coat the fiber with the at least one polymer or polymer precursor.

47. The system of claim 46 further comprising a dryer to remove at least a major portion of the liquid from the wet fiber, the dryer located upstream of the mixer or compounder.

48. The system of claim 46 wherein the dryer is a conveyor dryer.

49. The system of claim 46 wherein the dryer is part of the device for metering the wet fiber product.

48. The system of claim 46 wherein the mixer comprises a dryer section for drying the fiber.

49. A system for making a moldable mixture for making FRP products comprising a system for dispensing at least one wet roving fiber strand containing from about 0.5 to about 20 wt. percent of a liquid, a device for metering at least one polymer into a mixer or compounder, a mixer or compounder for breaking a roving strand of fibers into individual fibers of various lengths and dispersing the various length fibers into at least one polymer or polymer precursor to coat the fiber with the at least one polymer or polymer precursor and to form the moldable mixture.

50. The system of claim 49 further comprising a dryer to remove at least a major portion of the liquid from the at least one wet roving fiber strand, the dryer located upstream of the mixer or compounder.

51. The system of claim 50 wherein the dryer is a microwave or dielectric dryer.

52. The system of claim 51 wherein the dryer also moves air onto the at least one roving fiber strand to enhance drying.

53. The system of claim 50 wherein the dryer is a hot air convection dryer.

54. The method of claim 1 wherein the moldable material is then into FRP parts using any FRP forming process such as a forming process selected from the group consisting of injection molding, compression molding, sheet and profile extrusion, pultrusion, stamping, thermoforming, and blow molding.

55. FRP shapes made using the method of claim 1.

56. FRP shapes made using the method of claim 55.

57. The method of claim 2 wherein the moldable material is then into FRP parts using any FRP forming process such as a forming process selected from the group consisting of injection molding, compression molding, sheet and profile extrusion, pultrusion, stamping, thermoforming, and blow molding.

58. FRP shapes made using the method of claim 57

59. The method of claim 4 wherein the moldable material is then into FRP parts using any FRP forming process such as a forming process selected from the group consisting of injection molding, compression molding, sheet and profile extrusion, pultrusion, stamping, thermoforming, and blow molding.

60. FRP shapes made from the method of claim 59.

61. The method of claim 27 wherein the moldable material is then into FRP parts using any FRP forming process such as a forming process selected from the group consisting of injection molding, compression molding, sheet and profile extrusion, pultrusion, stamping, thermoforming, and blow molding.

62. FRP shapes made from the method of claim 27.

63. FRP shapes made from the method of claim 61.

64. The method of claim 28 wherein the moldable material is then into FRP parts using any FRP forming process such as a forming process selected from the group consisting of injection molding, compression molding, sheet and profile extrusion, pultrusion, stamping, thermoforming, and blow molding.

65. FRP shapes made from the method of claim 64.

66. The method of claim 34 wherein the moldable material is then into FRP parts using any FRP forming process such as a forming process selected from the group consisting of injection molding, compression molding, sheet and profile extrusion, pultrusion, stamping, thermoforming, and blow molding.

67. FRP shapes made using the method of claim 34.

68. FRP shapes made using the method of claim 66.

69. The method of claim 35 wherein the moldable material is then into FRP parts using any FRP forming process such as a forming process selected from the group consisting of injection molding, compression molding, sheet and profile extrusion, pultrusion, stamping, thermoforming, and blow molding.

70. FRP shapes made from the method of claim 35.
